(19) United States
(12) Patent Application Publication
(10) Pub. No.: US 2012/0234995 A1
(43) Pub. Date: Sep. 20, 2012

(54) SPRING SUPPORT AND METHOD FOR PRODUCING THE SAME

(76) Inventor: Tilko Dietert, Gunzenhausen (DE)

(21) Appl. No.: 13/497,428

(22) PCT Filed: Sep. 22, 2010
(86) PCT No.: PCT/EP2010/063976

§ 371 Date: Jun. 5, 2012

(30) Foreign Application Priority Data
Sep. 25, 2009 (DE) 10 2009 045 038.6

(51) Int. Cl. B60G 11/16; B29C 45/16

(52) U.S. Cl. 248/205.1; 264/255

(57) ABSTRACT

A spring support, particularly for a spring hanger of a motor vehicle, comprises an annular retaining element made of a thermoplastic material and a spring support element made of an elastomer material applied to the retaining element. The retaining element comprises at least one closed hollow space. A method is provided for producing such a spring support, wherein the method comprises introducing a melt of a thermoplastic material into an injection mold including at least two mold cores for configuring at least two through-openings in the thermoplastic material, injecting an expansion material for configuring a closed hollow space in the melt of the thermoplastic material and applying an elastomer material to the thermoplastic material. During injection of the expansion material, the mold cores are cooled and the expansion material is injected into at least two regions of the thermoplastic material separated from each other by the mold cores, in order to implement one closed hollow space in each of the regions.

### FIELD OF THE INVENTION

The invention relates to a spring support, in particular for a spring hanger of a motor vehicle, and a method for producing such a spring support.

### PRIOR ART

Spring supports are known from the prior art, which serve for accommodating the shock-absorber spring at the body (at the suspension-strut dome) of a motor vehicle and which contain a hole in the middle through which the shock absorber is led. The known spring supports consist of a massive thermoplastic molded part with material thicknesses of up to 17 mm, onto which an also very massive elastomeric component is molded by an insert-molding method and is thus held in a form-fitting manner at the thermoplastic molded part. The thermoplastic component serves in this regard for the correct placement of the spring support in the suspension-strut dome and supports the elastomeric component, in particular at the sides, while the elastomeric component itself accommodates one end of the shock-absorber spring and prevents noises when the motor vehicle is shock-absorbed.

Due to the high material thicknesses of the known spring support, it is very heavy and has high production costs owing to the used material and the necessary, long cooling and/or vulcanization times. Recesses provided in the spring support only marginally reduce the weight and the mass concentrations, however, further recesses are not possible for technical reasons related to the tool without inadmissibly reducing the strength of the support.

A further example of a spring support is disclosed in EP-B-0 924 445, the spring support described in this document having a disc-shaped body of an elastomeric material and a reinforcing inlay of synthetic material, embedded in this elastomeric body.

### DESCRIPTION OF THE INVENTION

The invention is based on the object to provide a spring support, in particular for a spring hanger of a motor vehicle, which can be manufactured simply and cost-efficiently, as well as a method for producing such a spring support.

This object is solved by the spring support with the features of claim 1 as well as a method with the features of claim 8. Advantageous embodiments are apparent from the other claims.

The spring sport according to the invention comprises an annular retaining element made of a thermoplastic material and a spring support element made of an elastomeric material, applied to the retaining element, wherein the retaining element comprises at least one closed hollow space. The retaining element hereby serves for the suitable arrangement of the spring support, for instance in a suspension-strut dome, and the mounting of the spring support element, while the spring support element abuts one end of a corresponding spring, for instance a shock-absorber spring. The term “closed hollow space” designates a hollow space which is surrounded entirely or at least for the major part by a thermoplastic material. For instance, the hollow space according to the invention can have one or a plurality of openings, such as e.g. injection openings. The retaining element of the spring support according to the invention is consequently configured as a closed hollow body. Such a hollow body with the same external dimensions as well as an even and sufficient wall strength (wall thickness) can have the same strength as a massive body. Thus, the spring support according to the invention offers a stability and durability, which can be compared to those of the massive spring supports known from the prior art. The provision of a hollow space in the retaining element, however, provides a considerable saving of material and a weight reduction of the spring support as well as the advantages given further below during production.

Preferably, the at least one closed hollow space is entirely surrounded by thermoplastic material with an essentially uniform thickness (wall strength). Due to manufacturing, minor mass concentrations in the axial edge areas of the component or adjacent to through-openings can thereby occur. An essentially uniform thickness of the walls surrounding the hollow space is therefore understood here as a component, in which the wall strength of the walls arranged around the hollow space radially or axially, e.g. adjacent to through-openings, is uniform apart from the above-stated mass concentrations. In this manner, a particularly high stability and durability of spring support can be guaranteed.

According to a preferred embodiment of the invention, the retaining element has at least one through-opening or a blind hole. The at least one through-opening can be suitable and dimensioned for guiding through a mounting element, such as a bolt or a screw, and thus for applying the spring support, for instance at a suspension-strut dome. Alternatively, a blind hole can serve for accommodating a screw protruding from the suspension-strut dome, at the same time a rough fixation of the spring support in the correct mounting position being able to be achieved. A through-opening in the retaining element can be filled with an elastomeric pin during overmolding with the elastomer, in order to achieve a form-fitting connection of the elastomer with the thermoplastic retaining element. Preferably, the retaining element according to the invention has a plurality of through-openings which can be arranged for instance along the circumference of the annular retaining element spaced apart from one another. If the retaining element has at least two through-openings, preferably at least two closed hollow spaces are provided in the retaining element, which are separated from each other by the at least two through-openings. However, it is also possible to provide more than two through-openings and accordingly more than two hollow spaces separated from each other by the through-openings. In this manner, weaknesses in the surroundings of the through-openings such as e.g. variations in the wall strength of the retaining element can be avoided, and thus a particularly high stability and durability of the spring support can be guaranteed.

According to a preferred embodiment, the retaining element and the spring support element are connected with each other in a form-fitting or cohesively/adhesively-bonded manner. In this manner, a permanent and robust connection of these components can be achieved, which can resist even greater forces exerted from outside onto the spring support.

Preferably, the at least one closed hollow space is filled with a gas, such as e.g. air. Thus, a considerable weight reduction of the spring support as compared to a support, which comprises a massive retaining element, can be achieved. Furthermore, such a spring support can be easily produced with methods known from the art, as will be described in detail below.

Alternatively, the at least one closed hollow space can also be partially or entirely filled with a material foamed as much as possible. If the hollow space according to the invention has an opening, such as e.g. an injection opening, in this manner the penetration of moisture, dirt or foreign objects into the interior of the retaining element can be reliably avoided when using the spring support.

Preferably, the spring support element consists of a thermoplastic elastomer. In this case, the spring support can be produced particularly simply and cost-efficiently in a fully-automated manner in a two-component injection molding method. In order to ensure the necessary compression set, the thermoplastic elastomer can be chemically cross-linked during curing or radiation crosslinked subsequently.

Furthermore, the invention provides a method for producing a spring support, in particular for a spring hanger of a motor vehicle, wherein the spring support comprises an annular retaining element made of a thermoplastic material and a spring support element made of an elastomeric material, applied to the retaining element, and the method comprises the following steps: introducing a melt of a thermoplastic material into an injection mold, said injection mold comprising at least two mold cores for forming at least two through-openings in the thermoplastic material, injecting an expansion material for forming a closed hollow space in the melt of the thermoplastic material and applying an elastomeric material to the thermoplastic material. Hereby, during the step of injecting the expansion material, the at least two mold cores are cooled, e.g. by high power cooling (high power hot spot cooling), and the expansion material is injected separately (individually) into at least two areas of the thermoplastic material separated from each other by the at least two mold cores, i.e. arranged between the at least two mold cores, in order to form one closed hollow space in each of said areas.

This manufacturing method makes it possible to guarantee even with a complicated structure of the retaining element, in particular in the surrounding area of the through-openings (for instance blind holes), a sufficient and even wall strength of the retaining elements in all areas.

Essentially, in the manufacturing method according to the invention known, special methods of injection molding, such as e.g. GIT (gas injection technique) or WIT (water injection technique) which are described for instance in DE-A-10 2005 062 825 and DE-A-10 2007 041 982, can be used. In these methods, the cavity of an injection mold is only filled partially and then a gas (GIT) or water (WIT) or another suitable liquid is injected into the melt of the synthetic material, in order to thus expand or “blow up” the thermoplastic material until it evenly abuts the walls of the cavity and a hollow space has been created in the interior of the synthetic material. After curing and solidification of the component and before the molding thereof, the gas or the water can be discharged or sucked off through an injection opening used for the injection of the expansion material. Remaining gas with low pressure can escape, after ejecting the component, through the injection opening into the surroundings, whereas the water or the other suitable liquid is preferably sucked off entirely. In this regard, the resulting wall strength of the retaining element can be controlled by the quantity of the melt introduced into the injection mold, the type and the pressure of the injected expansion material and locally by the extent of cooling at the mold wall. The time necessary for curing and/or solidification of the thermoplastic material can thus be significantly influenced by the temperature of the expansion material and consequently be controlled precisely.

The injection openings formed in the retaining element with such a method can remain in element or can be closed after the injection process, for instance by suitable covers of thermoplastic material or by deformation of the thermoplastic material formed during injection molding, e.g. in the form of a collar around the injection opening, by means of heat caulking or the like, in order to thus form closed hollow spaces without openings.

In the methods known from the art, such as e.g. GIT and WIT, the problem results here however that in particular in the surroundings of the through-openings no sufficient and even wall strength of the retaining element is formed. In particular the mold cores for forming the through-openings are heated so much in these methods that the melt in their surroundings does not cool down sufficiently, and consequently in these areas of the retaining element only a low wall strength is formed. Moreover, in this area the possible hollow space is so small that an expansion of the thermoplastic material at these narrow passages is not evenly possible. Thus, weaknesses can be generated in the retaining element, which can result in damage or even destruction of the spring support due to the high exterior forces when the spring support is used, for instance for a spring hanger of a motor vehicle.

This problem is solved by the manufacturing method according to the invention in that on the one hand the mold cores are strongly cooled, for instance by high power hot spot cooling, so that there the formation of a sufficient wall strength is guaranteed, and on the other hand the expansion material is injected separately and/or individually into the areas or segments of the thermoplastic material, which are arranged between the mold cores, so that in each of these areas one closed hollow space each is formed, the thus formed hollow spaces being separated from one another. In this manner, a stable wall with a defined thickness is formed in the surroundings of the through-openings. Moreover, with the cooling of the mold cores a fast solidification of the melt is achieved so that breaking through of the gas or water bubbles from one area or segment into another one is reliably prevented. In order that the available melt is sufficiently provided in all areas for expanding the synthetic material, the gate system can be configured accordingly, for instance in that a suitably dimensioned gate per area is provided. The manufacturing method according to the invention thus provides a simple and cost-efficient production of the spring support according to the invention and enables a low use of material, a low cooling time by avoiding mass concentrations as well as by improved cooling, on the one hand from the outside due to the high power cooling and on the other hand from the inside by the injected expansion material, and a low clamping force requirement since the holding pressure can be replaced by the pressure of the injected expansion material.

By means of the method according to the invention, the use of material and the vulcanization time can also be reduced for the elastomeric component since in the spring support known from the art this component is also unnecessarily thick in parts, since there the mass concentrations in the thermoplastic material would otherwise have to be made even greater. However, if the retaining element according to the present invention is configured as a hollow body—without mass concentrations—the exterior geometry of the retaining element can be changed such that the elastomeric component, i.e. the spring support element, can be reduced everywhere to the technically required wall strength. All in all, in this manner a weight reduction of the spring support of approximately 20% to 30% as compared to the spring supports known from the art can be achieved.

Preferably, a gas, a liquid or a foamed material is used as expansion material in the manufacturing method according to the invention. When using a gas, this can be preferably cooled in order to thus enable an even faster solidification of the melt, whereas when using a liquid a greater cooling effect is present anyway due to the higher heat capacity thereof. If a strongly foamed material is used as expansion material, this can be injected e.g. with the Stieler SmartFoam® method into the interior of the thermoplastic material. Such an approach provides the further advantages that injectors are not required in the mold cavity since the gas for following the core material can be supplied via a hot runner, that compact material can be injected again by switching off in due time the gas injection at the end of the injection process so that the wall of the created retaining element is compact everywhere, i.e. no injection hole remains in the component, that moisture, foreign objects or dirt cannot penetrate the interior of the spring support owing to the filling with foamed material and the closed wall, and that the foam structure additionally slightly increases the strength of the component. When using CO₂ as propellant for the foam, the good cooling effect from inside is retained.

Preferably, CO₂ cooling or Stemke-cooling is used for cooling the mold cores. In this regard, the CO₂ or, with Stemke-cooling, a refrigerant known from air-conditioning technology, e.g. R404a, is guided in liquid form through capillary tubes into the area to be cooled and evaporates there promptly due to expansion. Due to the phase transition, a large amount of heat energy is additionally withdrawn from the surroundings. In this manner, an efficient and fast cooling of the cores and thus a suitable solidification of the melt can be achieved.

The Stemke-Külung has the advantage as compared to the CO₂ cooling that the evaporated cooling medium is returned into a compressor and is liquefied there again so that it is used without wastage in a closed circuit, whereas with CO₂ cooling the CO₂ escapes into the environment after evaporation and thus CO₂ is constantly used.

The elastomeric material can be applied by molding onto the thermoplastic material by means of inserting the cured retaining element into the elastomer mold or, if the elastomer material is a thermoplastic elastomer, it can be applied onto the thermoplastic material in a two-component injection molding method.

In the latter case, a further reduction of the manufacturing costs can be achieved by avoiding long vulcanization times and a fully automatic execution of the manufacturing method.

### BRIEF DESCRIPTION OF THE DRAWINGS

Hereinafter, the present invention is described, only by way of example, by means of the enclosed figures, with

FIGS. 1(a) and (b) showing a perspective view of a motor vehicle shock absorber with the spring support according to the invention, FIG. 1(b) representing an enlarged view of the rectangular, framed area of FIG. 1(a);

FIG. 2 showing a perspective view of the spring support shown in FIG. 1 from the upper side thereof;

FIG. 3 showing a perspective view of the spring support shown in FIG. 1 from the lower side thereof; and

FIGS. 4(a) and (b) showing cross-sectional presentations of the spring support shown in FIG. 1 along the line A-A shown in FIG. 2, FIG. 4(b) representing an enlarged view of the rectangular, framed area of FIG. 4(a).

Ways of Implementing the Invention

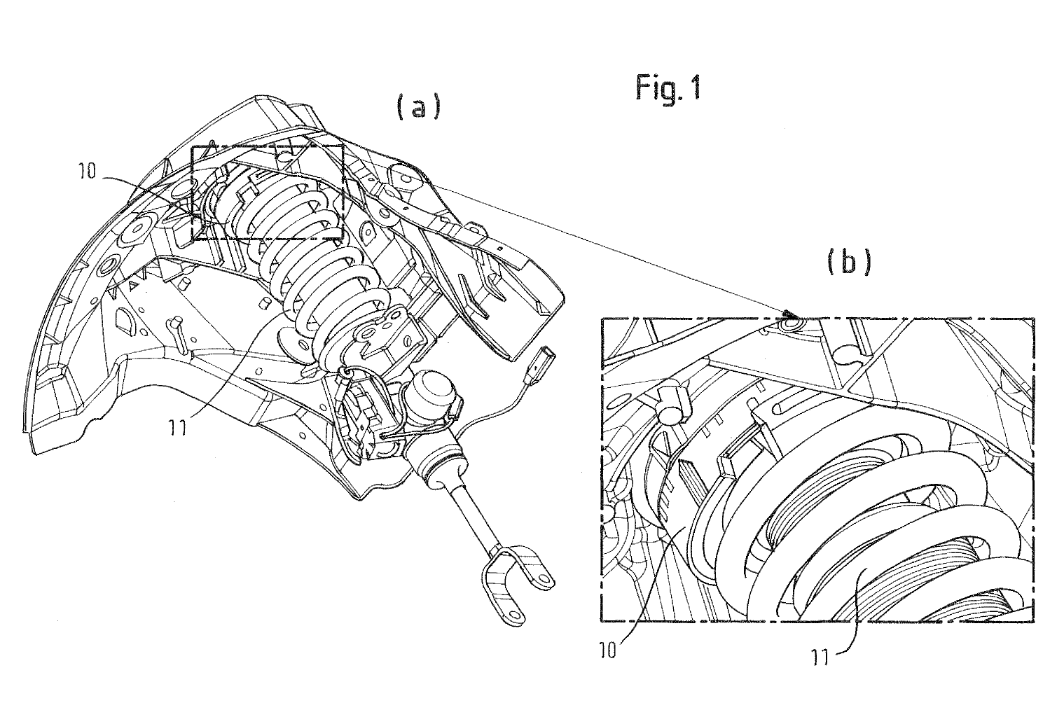

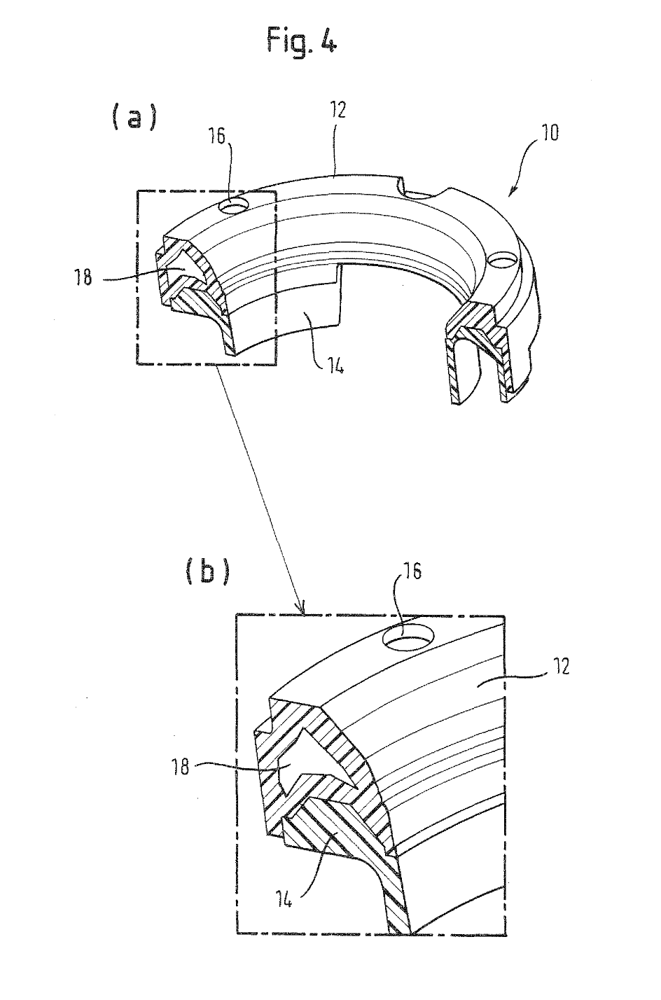

FIG. 1 shows the spring support 10 according to the invention in the installed stated in a suspension-strut dome of a motor vehicle shock absorber. As apparent in particular from FIG. 1(b), one end of the shock-absorber spring 11 is partially accommodated in the spring support 10, where it abuts the spring support element 14 shown e.g. in FIG. 3.

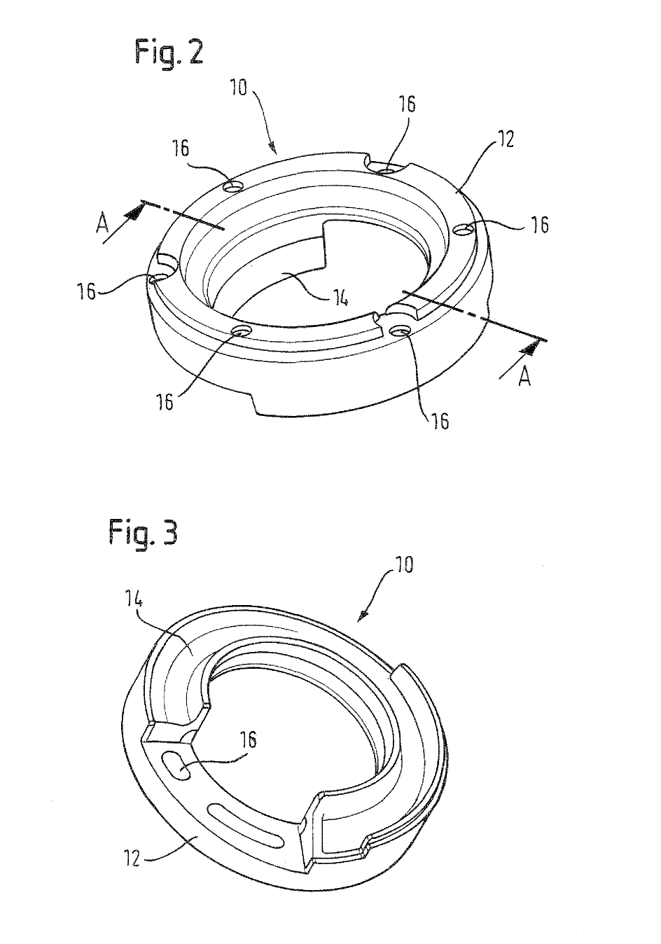

The detailed configuration of spring support 10 according to the present embodiment is shown in FIGS. 2-4. The spring support 10 comprises a retaining element 12 in addition to the above-mentioned spring support element 14, with these two components 12, 14 being connected with each other in a form-fitting manner. The retaining element 12 consists of a thermoplastic material, e.g. a polyamide with high glass fiber content (approximately 30% to 50%) and the spring support element 14 consists of an elastomer, e.g. styrene butadiene rubber (SBR).

The annular-formed retaining element 12 has through-openings 16 which extend from the upper side to the lower side of the retaining element 12 and partially even through the spring support element 14 and enable the mounting of the spring support 10 in the suspension-strut dome by suitable mounting elements, such as e.g. screws or bolts.

As shown in FIGS. 4(a) and (b), the retaining element 12 is formed as a hollow body and comprises hollow spaces 18 arranged between the through-openings 16, each extending along a section of the retaining element circumference. In the present embodiment, 6 through-openings 16 and 6 hollow spaces 18 separated from each other in the circumferential direction of the retaining element 12 are provided, each of the hollow spaces 18 lying between two through-openings 16 and abutting these. The wall strength of the walls surrounding the hollow spaces 18 of the retaining element 12 is essentially uniform and is 3 to 5 mm.

In the present embodiment, the hollow spaces 16 are filled with air. As already described above, however, also foamed material, such as for instance a foamed synthetic material, can be used for filling the hollow spaces 18. Depending on the field of use of the spring support, different hollow spaces 18 can also be filled with different expansion media, in particular in part containing gases.

As can be gathered from FIGS. 4(a) and (b), the spring support 10 according to the invention provides a considerable saving of material and thus enables an essential reduction of the weight of the support 10 as well as a simple and cost-efficient production thereof.

For producing the embodiment of the spring support 10, as shown in FIGS. 1-4, for instance a GIT or WIT method can be used, in which during the injection of the expansion material, i.e. of the gas, water etc., into the thermoplastic material the—in this case 6—mold cores of the injection mold are cooled by a CO₂ or Stemke-cooling, and the expansion material is injected separately into the 6 areas of the thermoplastic material, which are separated from each other by the mold cores, in order to form a closed hollow space 18 in each of these areas. The elastomeric material of the spring support element 14 can be applied in a two-component injection molding method to the thermoplastic material of the retaining element 12.

The injection openings formed in such a method in the retaining element 12 can remain in the element 12 or can be closed after the injection process, for instance with corresponding covers of thermoplastic material, in order to thus form closed hollow spaces 18 without openings.

The invention is not restricted to the described embodiment, but can be modified within the scope of the following claims.

1. A spring support for a spring hanger of a motor vehicle, the spring support comprising
an annular retaining element made of a thermoplastic material; and
a spring support element made of an elastomeric material, applied to the retaining element,
wherein the retaining element includes at least one closed hollow space.

2. The spring support according to claim 1, wherein the retaining element has at least one through-opening.

3. The spring support according to claim 2, wherein the retaining element has at least two through-openings and at least two closed hollow spaces which are separated from one another by the at least two through-openings.

4. The spring support according to claim 1, wherein the retaining element and the spring support element are connected with each other in a form-fitting or cohesively/adhesively-bonded manner.

5. The spring support according to claim 1, wherein the at least one closed hollow space is filled with a gas.

6. The spring support according to claim 1, wherein the at least one closed hollow space is filled at least partially with a foamed material.

7. The spring support according to claim 1, wherein the spring support element consists of a thermoplastic elastomer.

8. A method for producing a spring support for a spring hanger of a motor vehicle, the spring support comprising an annular retaining element made of a thermoplastic material and a spring support element made of an elastomeric material, applied to the retaining element, the method comprising acts of:
introducing a melt of a thermoplastic material into an injection mold, said injection mold comprising at least two mold cores for forming at least two through-openings in the thermoplastic material;
injecting an expansion material for forming a closed hollow space in the melt of the thermoplastic material; and
applying an elastomeric material to the thermoplastic material; wherein
during the step of injecting the expansion material, the at least two mold cores are cooled and the expansion material is injected into at least two areas of the thermoplastic material separated from each other by the at least two mold cores, to form one closed hollow space in each of said areas.

9. The method according to claim 8, wherein the expansion material is a cooled gas, a liquid or a foamed material.

10. The method according to claim 8, wherein the cooling is carried out by Stemke-cooling or CO2 cooling.

11. The method according to claim 8, wherein the elastomeric material is applied by molding onto the cured thermoplastic material.

12. The method according to claim 8, wherein the elastomeric material is a thermoplastic elastomer and is applied onto the thermoplastic material with a two-component injection molding method.
